(19) United States
(12) Patent Application Publication
(10) Pub. No.: US 2012/0148990 A1
(43) Pub. Date: Jun. 14, 2012

(54) PRACTICE APPARATUS, PRACTICE SYSTEM AND PRACTICE APPARATUS CONTROL METHOD

(75) Inventors: Takesi Kawaguti, Shizuoka (JP); Masanori Sambe, Shizuoka (JP)

(73) Assignee: TOSHIBA TEC KABUSHIKI KAISHA, Tokyo (JP)

(21) Appl. No.: 13/294,324

(22) Filed: Nov. 11, 2011

(30) Foreign Application Priority Data
Dec. 9, 2010 (JP) 2010-274569

(51) Int. Cl. G09B 19/00

(52) U.S. Cl. 434/219

(57) ABSTRACT

In one embodiment, a practice includes a display device, a first controller, an input device and a second controller. The first controller, which controls the display device by displaying an input interface image in the first display area of the display device. The second controller, which controls the display device by playback a dynamic image representing a cue event indicating a cue of the operation in the second display area of the display device, or by continuously displaying a plurality of still images including an image related to a cue event. The second controller stops the playback of the dynamic image or the continuous display of the still images during the period from the moment an image related to a cue event is displayed to the moment an operation is input through the input device that is to be carried out by taking the cue event as a cue.

### CROSS-REFERENCE TO RELATED APPLICATION

This application is based upon and claims priority from prior Japanese Patent Application No. 2010-274569, filed on Dec. 9, 2010, the entire contents of which is incorporated herein by reference.

### FIELD

Embodiments described herein relate generally to a practice apparatus, a practice system and a practice apparatus control method.

### BACKGROUND

A processor is used in most eating and drinking establishments such as restaurant and bar to realize menu item order acceptation service, charging service and other services.

Moreover, this processor uses an input device to input the operation of a user such as a shop assistant and executes corresponding processing in response to the input operation.

Specifically, when used in a system installed in an eating/drinking establishment, the input device and the processor refer to, for example, an order terminal and a base station (server), respectively. Moreover, in this case, the order terminal inputs the operation which specified menu items for the order of the customer. The order terminal generates, according to the input operation, order acceptation information including a list of the ordered menu items, and sends the order acceptation information to the base station. The base station generates a cooking instruction bill or performs a sales management according to the order acceptation information.

The user can practice operating the input device in practice or in a simulation environment in which other shop assistants play the role of customers.

In view of the situation above, it is expected that the user can be familiar with the operation of the input device in a simple way.

### DESCRIPTION OF THE DRAWINGS

FIG. 1 is a structural diagram of an order processing system according to an embodiment;

FIG. 2 is a block diagram of the information terminal shown in FIG. 1;

FIG. 3 is a schematic diagram illustrating an example of a practice course database;

FIG. 4 is a schematic diagram illustrating an example of a practice condition database;

FIG. 5 is a diagram illustrating an example of the information recorded in a guidance setting file;

FIG. 6 is a flowchart of the practice executed by the CPU shown in FIG. 2;

FIG. 7 is a diagram illustrating an example of a display screen including a course selection image;

FIG. 8 is a diagram illustrating an example of a display screen including a practice image;

FIG. 9 is a diagram illustrating an example of a display screen including course selection images;

FIG. 10 is a flowchart of the execution of the CPU shown in FIG. 2 on the actions given in a guidance mode;

FIG. 11 is a diagram illustrating an example of a practice image resulting from a change on the input interface image while the regeneration of a dynamic image is paused;

FIG. 12 is a diagram illustrating the structure of a practice system using a cloud system.

### DETAILED DESCRIPTION

In general according to one embodiment, a practice includes a display device, a first controller, an input device and a second controller. The first controller, which controls the display device by displaying an input interface image which simulates an aspect of a user interface for inputting the operation to the input device in the first display area of the display device. The input device for inputting the operation of the user on the input interface image displayed on the display. The second controller, which controls the display device by playback a dynamic image representing at least one cue event indicating a cue of the operation in the second display area of the display device, or by continuously displaying a plurality of still images including at least one image related to a cue event. The second controller stops the playback of the dynamic image or the continuous display of the still images during the period from the moment an image related to a cue event is displayed to the moment an operation is input through the input device that is to be carried out by taking the cue event as a cue.

The embodiments are described below by reference to accompanying drawings.

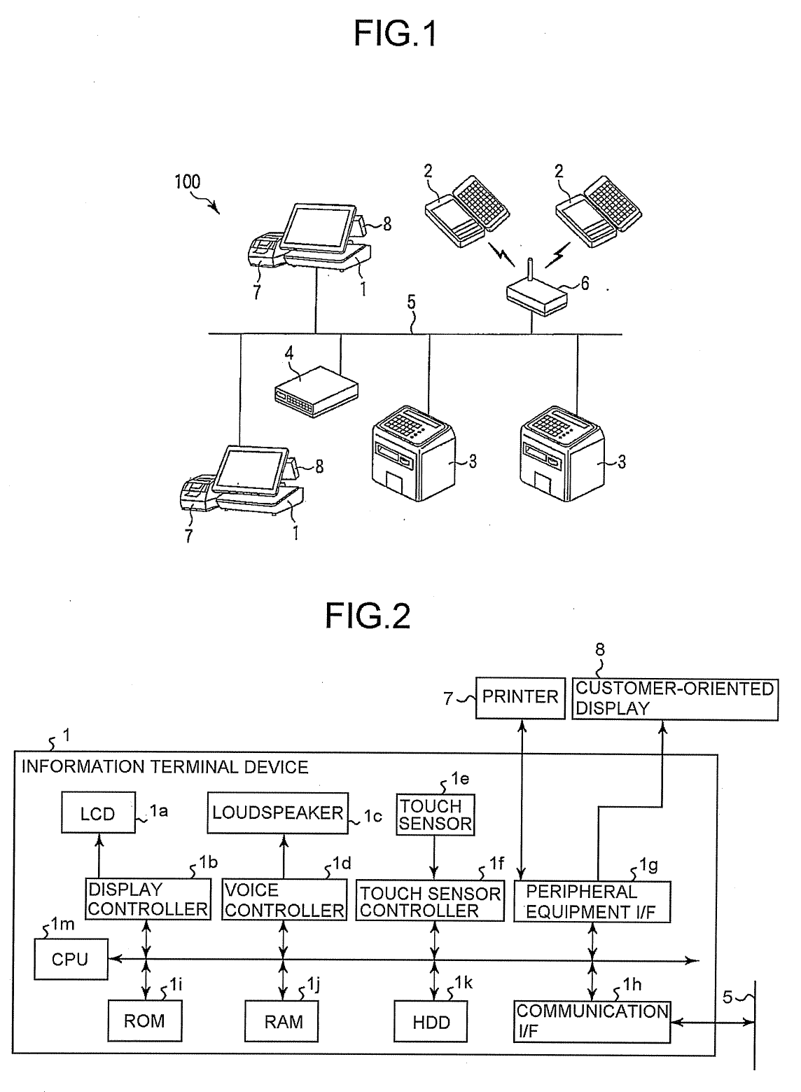

FIG. 1 is a structural diagram of an order processing system 100 related to an embodiment of the present invention.

The order processing system 100 is used in a facility which provides services such as food/beverage service and commodity sales service according to the order of the customer of an eating/drinking establishment or a shop. However, the following description is only given on an order processing system 100 constituting a device for the use in an eating/drinking establishment.

The order processing system 100 is formed by respectively connecting a plurality of information terminals 1, a plurality of hand-hold terminals 2, a plurality of bill printers 3 and a base station 4 with a LAN 5. However, the hand-hold terminals 2 are connected with the LAN 5 via a wireless access point 6. In FIG. 1 and FIG. 2, there are shown two information terminals 1, two hand-hold terminals 2 and two bill printers 3, however, it should be appreciated that the number of these components can be any positive integer, for example, 1.

The information terminal 1 is set in, for example, a service floor or at a checkout counter to carry out processing related to customer guidance service, order reception service, serving (dish serving), charging service and the like. Moreover, the processing related to guidance service, order reception service and serving (dish serving) is carried out in the information terminal 1 set in a parlor. The processing related to charging is carried out in the information terminal set at a checkout counter. In addition, the information terminal 1 can be dedicated to some of the services above. At least one of the information terminals 1 can execute the practice processing described later and serve as a practice apparatus.

The hand-hold terminal 2 comprises a user interface on which a plurality of operation keys including soft keys and hard keys are arranged and serves as an input device which allows the user to input an order through the user interface. The terminal 2 generates order information according to the input operation and sends the order information in a wireless manner. The order information wirelessly sent from the hand-hold terminal 2 is transmitted to the base station 4 via the wireless access point 6 and the LAN 5.

The bill printer 3 is set in, for example, a service floor or kitchen. The bill printer 3 set in a service floor prints, for the customer, an order bill based on the order information. That is, the bill printer 3 in a service floor serves as the called customer printer. The bill printer 3 in a kitchen prints, for the cooker, a cooking instruction bill based on the order information. That is, the bill printer 3 set in a kitchen serves as the called kitchen printer.

The base station 4 is set in, for, example, a backyard to gather all the information sent from the information terminal 1 and to carry out operations restrained to the management service of an eating/drinking establishment. Moreover, the base station 4 further manages the information shared by the plurality of information terminals 1 in some cases.

FIG. 2 is a block diagram of the information terminal 1.

The information terminal 1 comprises a liquid crystal display (LCD) 1a, a display controller 1b, a loudspeaker 1c, a voice controller 1d, a touch sensor 1e, a touch sensor controller 1f, a peripheral equipment interface 1g (peripheral equipment 1/F), a communication interface 1h (communication I/F), a read-only memory (ROM) 1i, a random access memory (RAM) 1j, a hard disk drive (HDD) 1k and a central processing unit (CPU) 1m, wherein the display controller 1b, the voice controller 1d, the touch sensor controller 1f, the peripheral equipment interface 1g, the communication interface 1h, the ROM 1i, the RAM 1j, the HDD 1k and the CPU 1m are respectively connected with a bus line. The LCD 1a, the loudspeaker 1c and the touch sensor 1e are respectively connected with the display controller 1b, the voice controller 1d and the touch sensor controller 1f.

The LCD 1a displays images under the drive of the display controller 1b. The display controller 1b drives the LCD 1a by displaying an image in response to the image data transmitted under the control of the CPU 1m.

The loudspeaker 1c regenerates the voice driven by the voice controller 1d. The voice controller 1d drives the loudspeaker 1c by playback the voice in response to the voice data transmitted under the control of the CPU 1m.

The touch sensor 1e is laminated on the display panel of the LCD 1a. When the user touches the picture displayed on the LCD 1a, the touch sensor 1e outputs a detection signal in response to the touch position. The touch sensor controller 1f calculates the coordinate information of the touch position according to the detection signal output from the touch sensor 1e and sends the coordinate information to the CPU 1m. When used for practice, the touch sensor 1e can serve as one of the input devices for inputting the operation of the user in practice.

The peripheral equipment interface 1g is connected with a piece of peripheral equipment such as a printer 7 or a customer-orientated display 8 as needed. The peripheral equipment interface 1g communicates with the connected peripheral equipment. The peripheral interface 1g may be an interface circuit in accordance with general standards such as universal serial bus (USB). In addition, the printer 7 is used to print an order bill, an invoice or various journals. The customer-orientated display 8 is used to display expense amount or advertisement information for the customer. At least one of the printer 7 and the customer-orientated display 8 is installed in the information terminal 1.

The communication interface 1h communicates with the LAN 5 via the bill printer 3 and the base station 4. The communication interface 1g may be an interface circuit in accordance with general standards such as Ethernet (trademark).

The ROM 1i is arranged to store a program recording the processing Acts to be implemented by the CPU 1m as well as the data need by the CPU 1m to execute various processing.

The RAM 1j stores the data need by the CPU 1m to execute various processing as needed. For instance, the RAM 1j stores the image information representing the image shown on the LCD 1a. Moreover, the RAM 1j is further used as a working area for the CPU 1m to carry out various processing.

The HDD 1k is arranged to store a program recording the processing Acts to be implemented by the CPU 1m as well as the data need by the CPU 1m to execute various processing. The HDD 1k stores a database related to the menu items supplied by a restaurant equipped with the order processing system 100. The HDD 1k stores the data of the input interface image which simulates the user interface of the hand-hold terminal 2. The HDD 1k stores a practice course database in which the content of individual practice course is separately recorded. The HDD 1k stores a practice condition database in which the practice condition of individual shop assistant is recorded. The HDD 1k stores the dynamic image files regenerated during a practice. Further, the HDD 1k stores a plurality of guidance setting files recording a setting for a guidance practice.

The CPU 1m executes various processing or practices related to the various services above according to the program stored in the ROM 1i or the HDD 1k.

In addition, the information terminal 1 can be sold or transferred while programs are stored in the ROM 1i or the HDD 1k, or the state stored in the storage medium, or the program sold or transferred via the communication of the communication line is optionally installed in the information terminal 1. Further, all kinds of mediums can be used as the memory medium, such as magnetic disc, magneto-optical disc, optical disc or semiconductor memory.

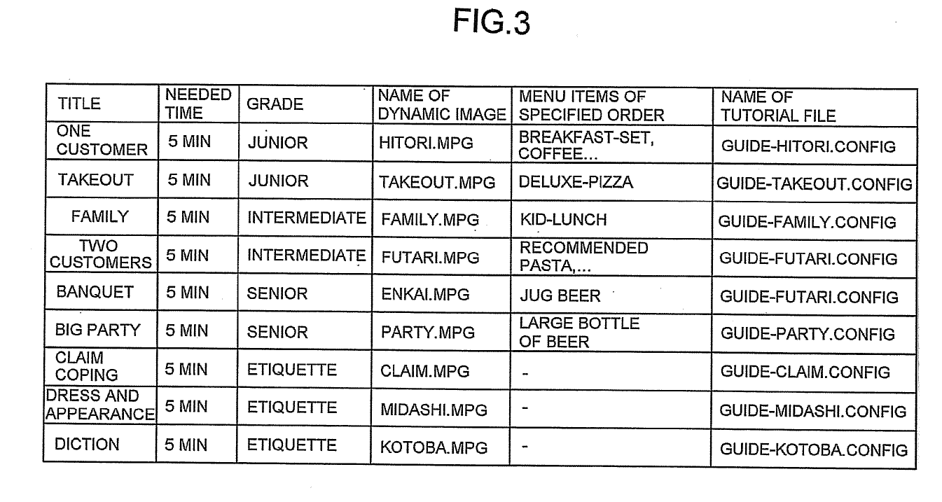

FIG. 3 is a schematic diagram illustrating an example of a practice course database.

As shown in FIG. 3, the practice course database contains data records, each of which is corresponding to a practice course. Each data record includes information fields related to a title, a needed time, a grade, a dynamic image file name, the menu item of a specified order and the name of a guidance setting file. The information recorded in the title-related information field represents a title for identifying a practice course. The information recorded in the information field related to a needed time represents the time needed for a practice course. The information recorded in the grade-related information field represents how difficult a practice course is. The information recorded in the information field related to a dynamic image file name represents the identification name of a dynamic image file to be used. The information recorded in the information field related to the menu items of a specified order represents the menu items to be input as the menu items of an order. The information recorded in the information field related to the name of a guidance setting file represents the identification name of a guidance setting file recorded the settings for the guidance according to each practice course.

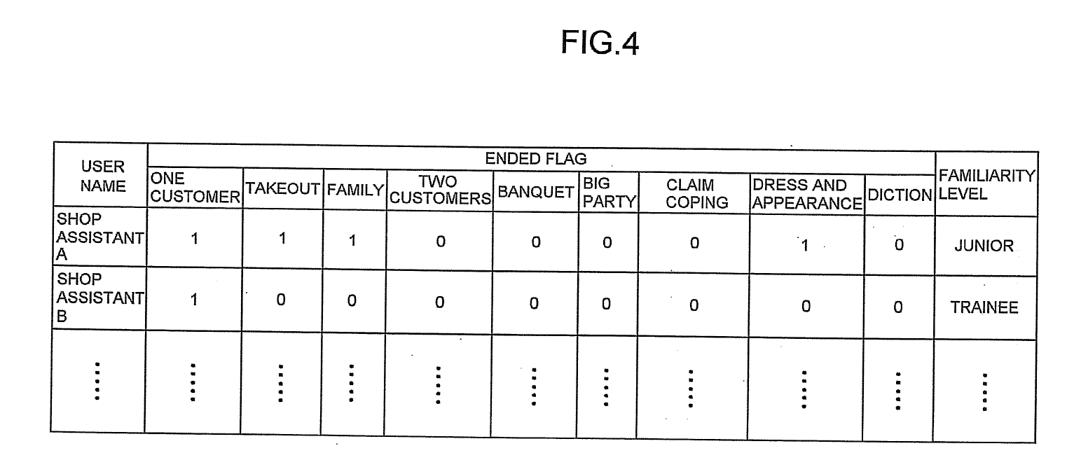

FIG. 4 is a schematic diagram illustrating an example of a practice condition database.

As shown in FIG. 4, the practice condition database contains data records, each of which is corresponding to a user (refer here to a shop assistant). Each data record includes information fields related to a user name, a flag of each practice course finished and a familiarity level. The information recorded in the information field related to a user name represents a name for identifying a user. The ended flag, which may be either 0 (uncompleted) or 1 (completed), represents whether or not a practice course is completed. The information recorded in the information field related to a familiarity level represents the familiarity level of the operator of the hand-hold terminal 2.

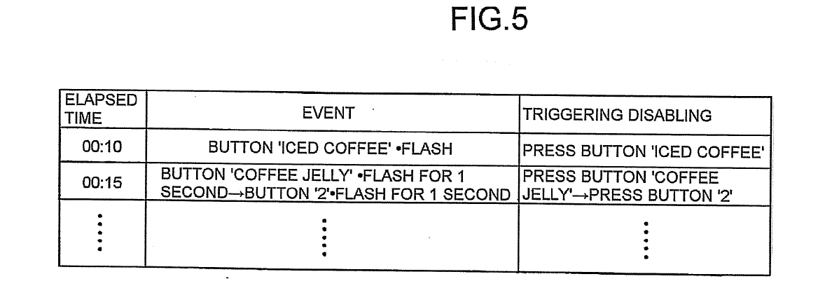

FIG. 5 is a diagram illustrating an example of the information recorded in a guidance setting file.

As shown in FIG. 5, a guidance setting file is a set of the setting information on an elapsed time, an execution event and a release triggering.

The elapsed time represents a fixed time for the automatic pause of a dynamic image. The execution event represents an action to be executed when the dynamic image is paused. The release triggering refers to an operation of disabling the triggering for the pause of the dynamic image. Specifically, the information represented by the settings is respectively preset as follows: the fixed time represented by the elapsed time is set the operation for input a menu item in hand-hold terminal 2 as a timing for display image related to a event which is cue of the user should carry out (named “cue event” in the below). The execution event is set the operation item that the user should carry out as the change content of the input interface image for inform user. The trigger timing is set as the operation item that the user should carry out.

If the first setting information shown in FIG. 5 indicates that a customer orders iced coffee after the dynamic image is regenerated for [00:10], then the regeneration of the dynamic image is paused by taking this moment [00:10] as a cue. Moreover, the first setting information shown in FIG. 5 further indicates that the pause of the dynamic image is disabled by pressing the ‘iced coffee’ button on the input interface image described later once the ‘iced coffee’ button is flashing.

Below is description on the action of the order processing system 100.

When the user inputs an order to the information terminal 1 or the hand-hold terminal 2, order information is generated in the information terminal 1 or the hand-hold terminal 2 according to the operation of the user and then transmitted to the base station 4 via the LAN 5. The base station 4 manages the order information received for the sake of expense calculation or expense summation. Moreover, the base station 4 sends the order information to the bill printer 3 via the LAN 5. The bill printer 3 prints a cooking instruction bill or an order bill in response to the order information received.

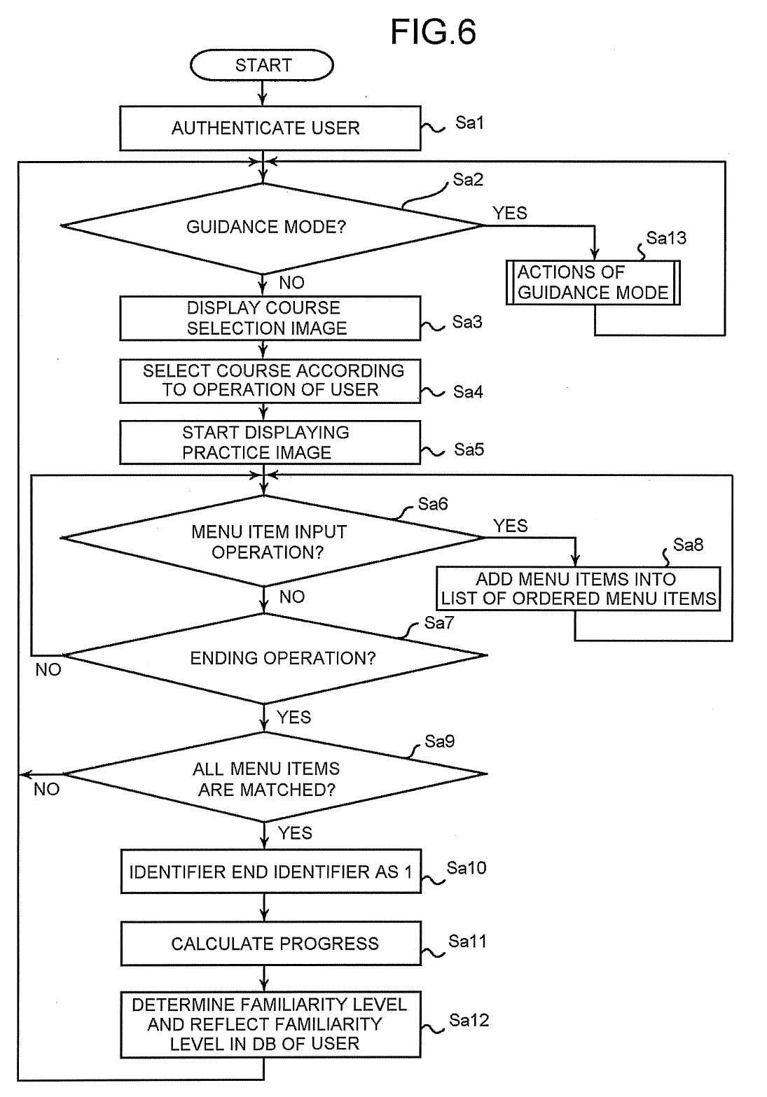

Next, when desiring to practice operating the hand-hold terminal 2, the user uses the practice functions provided by the information terminal 1. In the information terminal 1 the practice function of which is required by the user to be activated, the CPU 1m carries out the practice shown in FIG. 6.

In Act Sa1, the CPU 1m authenticates a user.

In Act Sa2, the CPU 1m determines whether or not to set a guidance mode according to the operation of the user. Further, the CPU 1m proceeds to execute Act Sa3 after executing Act Sa2 if no guidance mode is set.

In Act Sa3, the CPU 1m instructs the display controller 1b by generating and displaying a course selection image. According to the instruction, the display controller 1b drives the LCD 1a by displaying a matched course selection image.

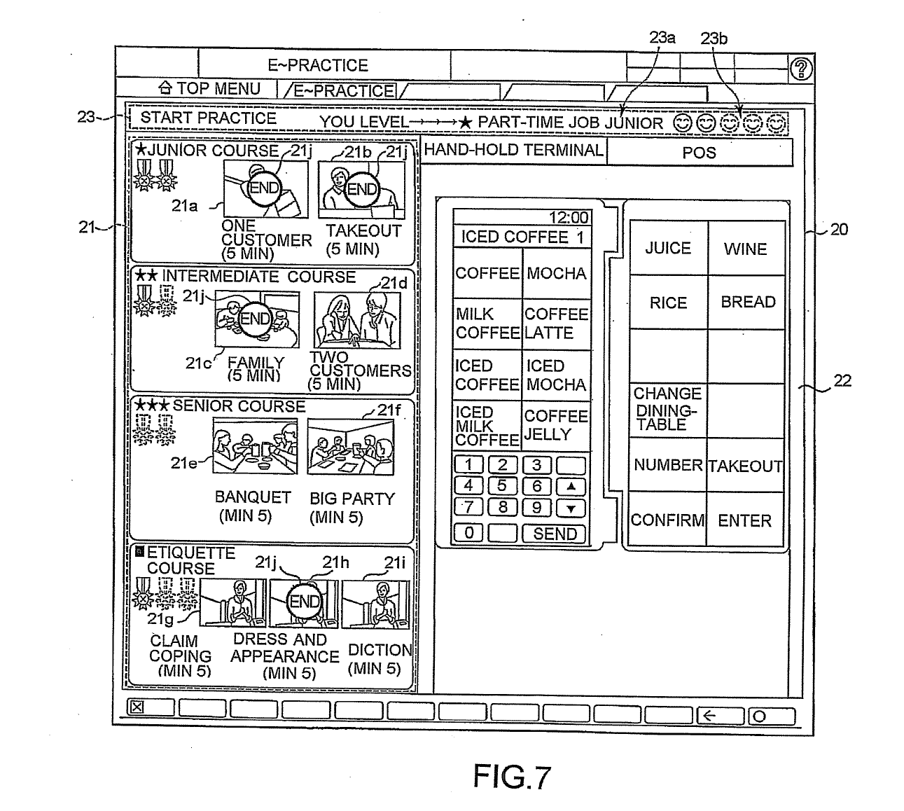

FIG. 7 is a diagram illustrating an example of a display screen including a course selection image 20.

The course selection image 20 comprises an overall course image 21, an input interface image 22 and a guide image 23.

The overall course image 21 provides the general view of the practice courses registered in a practice course database. In the example shown in FIG. 7, the overall course image 21 comprises the dynamic thumbnails 21a, 21b, 21c, 21d, 21e, 21f, 21g, 21h and 21i of the practice courses contained in the overall course image 21. The title of each practice course and the text indicating the practice time needed by each practice course are contained below the dynamic thumbnails 21a-21i shown in the overall course image 21. Moreover, the overall course image 21 shows the dynamic thumbnails 21a-21i separately in accordance with the levels of the practice courses.

Moreover, in the course list image 21, about authenticated user in Act Sa1, an ended flag 21j which is expressed practice end is overlapped with the dynamic thumbnail image of a practice course which is an ended flag “1” set in the practice condition database. In the practice condition database shown in FIG. 4, the practice courses of a user ‘shop assistant A’ with an ended flag ‘1’ are ‘one customer’, ‘takeout’, ‘family’ and ‘dress and appearance’. Accordingly, the ended flags 21j are contained In FIG. 7 that are respectively overlapped with the dynamic thumbnails 21a, 21b, 21c and 21h of practice courses ‘one customer’, ‘takeout’, ‘family’ and ‘dress and appearance’.

The input interface image 22 is an image which simulates the appearance of the user interface of the hand-hold terminal 2.

The guide image 23 comprises a string 23a and a mark 23b representing the familiarity level of the user.

In Act Sa4, the CPU 1m selects a practice course according to the selection of the user. Specifically, the CPU 1m selects a practice course related to the user-touched dynamic thumbnail contained in the overall course image 21. If the user touches the display area of the dynamic thumbnail 21d shown in FIG. 7, then the CPU 1m selects the practice course with a title of ‘two customers’.

In Act Sa5, the CPU 1m starts displaying the dynamic image corresponding to the selected practice course. If the selected is, for example, a practice course with a title of ‘two customers’, then the CPU 1m acquires, according to the practice course database, ‘Futari.mpg’ as a dynamic image file name, and generates a practice image including the dynamic image that is stored in the dynamic image file in he HDD 1k with the name ‘Futari.mpg’. Moreover, the CPU 1m instructs the display controller 1b by displaying the practice image. According to this instruction, the display controller 1b drives the LCD 1a by displaying a matched practice image. In addition, the CPU 1m instructs the voice controller 1d by playback the voice corresponding to the voice data contained in the dynamic image file. According to this instruction, the voice controller 1d drives the loudspeaker 1c by playback a matched voice. In addition, the CPU 1m regenerates the dynamic image and the voice by, for example, executing a processing based on the other tasks of a piece of well-known play software.

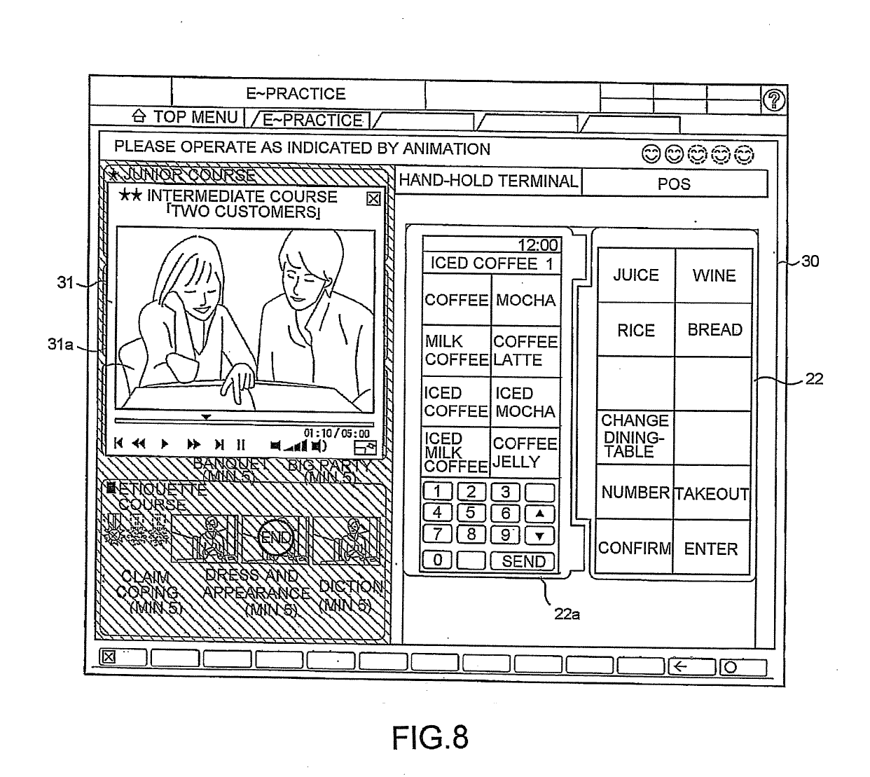

FIG. 8 is a diagram illustrating an example of a display screen including a practice image 30.

The practice image 30 include a display image 31, such that the course selection image 20 is overlapped with the overall course image 21. The display image 31 comprises a dynamic image 31a. In addition, the CPU 1m selects, one by one, a plurality of image frames represented by dynamic image files as display objects at fixed time interval and automatically changes the image frames shown as the display objects of the dynamic image 31a. The dynamic image and voice represented by the dynamic image file represents a plurality of cue events that vary with time. The dynamic image and voice refers specifically to an animation showing the menu ordering of customer and the like.

According to the dynamic image displayed on the LCD1a and the voice regenerated by the loudspeaker 1c, the user touches the menu item button on the input interface image 22 to input the ordered menu item. Moreover, after inputting all the ordered menu items, the user touches the button ‘send’ 22a on the input interface image 22 to end the operation.

Moreover, in Acts Sa6 and Sa7, the CPU 1m waits for the input of menu items or an operation end. Further, if menu items have been input, the CPU 1m proceeds to execute Act Sa8 after executing Act Sa6.

In Act Sa8, the CPU 1m adds the input menu items to the list of the ordered menu items. Then, the CPU 1m returns to execute Acts Sa6 and Sa7 to be in wait state.

If an ending operation is carried out while the CPU 1m is in the wait state in Acts Sa6 and Sa7, the CPU 1m proceeds to execute Act Sa9 after executing Act Sa7. In addition, after executing Act Sa7, the CPU 1m may proceed to execute Act Sa9 even at the regeneration ending moment of the dynamic image or in the case where no ending operation is carried out within a given period after the regeneration ending moment of the dynamic image.

In Act Sa9, the CPU 1m determines whether or not the menu items contained in the list of the ordered menu items are the same as those contained in the menu item of a specified order recorded in the practice course database of the currently selected practice course. If so, the CPU 1m proceeds to execute Act Sa10 after executing Act Sa9.

In Act Sa10, the CPU 1m marks the ended flag that is contained in the practice condition database of the user authenticated in Act Sa1 and related to the currently selected practice course as ‘1’.

In Act Sa11, the CPU 1m calculates the practice progress achieved by the user authenticated in Act Sa1. The progress may be calculated according to any preset rule. For instance, the progress may be calculated by calculating the number of the practice course with an ended flag ‘1’. In this case, if the practice condition database is in the state shown in FIG. 4, then the progress achieved by the user ‘shop assistant A’ is ‘4’. Or, the progress may be calculated by calculating a coefficient corresponding to the difficulty of a practice course and the total number of multiply ended flags. That is, if coefficients related to courses ‘Junior’, ‘Intermediate’, ‘Senior’ and ‘Dress and Appearance’ are set to be ‘1’, ‘2’, ‘3’ and ‘1’ according to the grades of the practice courses, then, if the practice condition database is in the state shown in FIG. 4, the progress achieved by the user ‘shop assistant A’ is ‘5’.

In Act Sa12, the CPU 1m determines the familiarity level of the user and reflects the familiarity level in the practice condition database. Specifically, the correspondence relationship between a progress and a familiarity level is preset. In addition, the familiarity level refers to such an index as ‘Part-time job Junior’ and ‘part-time jib Intermediate’ for measuring the familiarity level of a user. Further, the CPU 1m makes no change in the practice condition database if the progress increases while the familiarity level is unchanged. However, the CPU 1m changes the record in the information field of the practice condition database related to a familiarity level if the familiarity level increases with the progress. More specifically, if the user ‘shop assistant A’ completes the practice course ‘two customers’ correctly, the CPU 1m determines the familiarity level of the user to be ‘part-time job intermediate’. In this case, the CPU 1m updates the practice condition database, for example in FIG. 4, by changing “part-time job junior” into “part-time job intermediate”, the description of the information field related to the familiarity level in a date record which recorded “shop assistant A” in the information field in a user name.

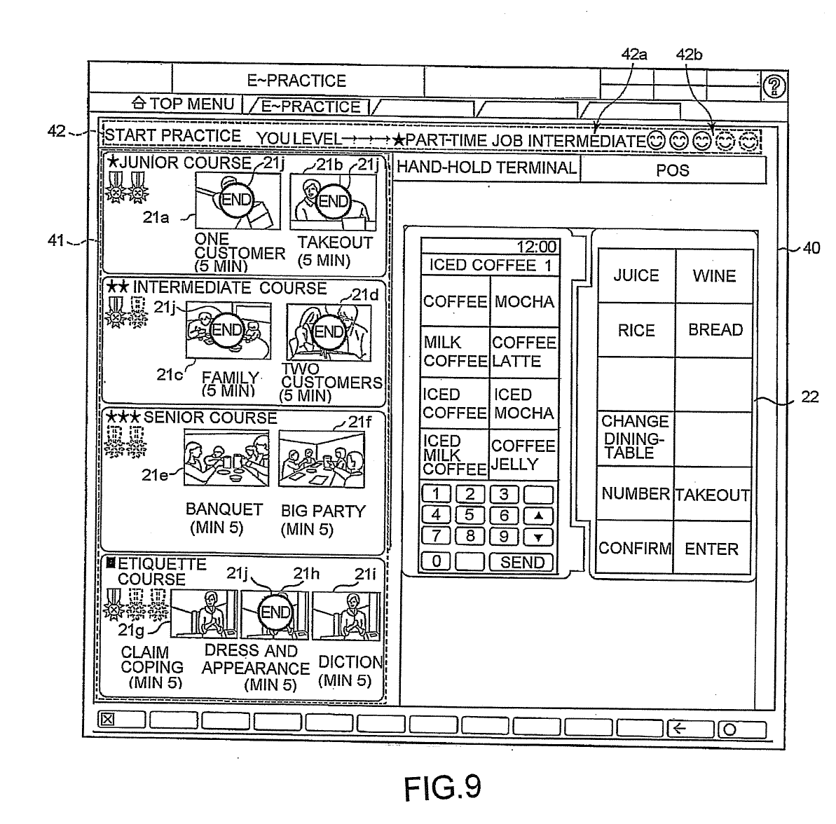

Then, the CPU 1m returns to execute Act Sa3 to display the course selection image again. At this time, the CPU 1m generates a course selection image according to the information recorded in the updated practice condition database. Thus, if the practice condition database is updated as, for example, in the specific example above, the image shown in FIG. 9 is shown again as a course selection image. The course selection image 40 shown in FIG. 9 comprises an ended flag 21j that is overlapped with the dynamic thumbnail 21d in an overall course image 41, which is different from the overall course image 21. Moreover, the course selection image 40 comprises a string 42 and a mark 42b representing the changed familiarity level in a guide image 42, which is different from the guide image 23.

If determining the menu items contained in the list of the ordered menu items are different from those contained in the menu items of a specified order recorded in the practice course database of the currently selected practice course, the CPU 1m returns to execute Act Sa3 after executing Act Sa9. At this time, as the practice condition database is not updated, the course selection image 20 shown in FIG. 7 is shown again.

Then, the CPU 1m proceeds to execute Act Sa13 after executing Act Sa2 when the user sets a guidance mode so as to execute the actions given in the guidance mode.

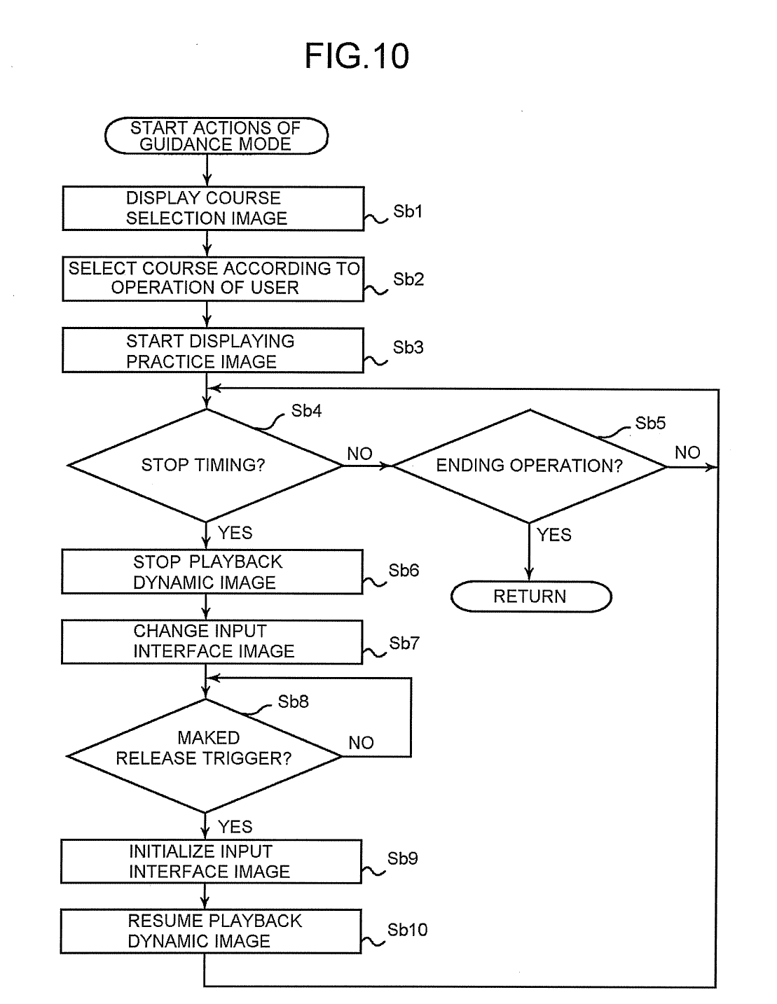

FIG. 10 is a flowchart of the execution of the CPU shown in FIG. 2 on the actions given in a guidance mode.

In Act Sb1, the CPU 1m instructs the display controller 1b by generating and displaying a course selection image. According to the instruction, the display controller 1b drives the LCD 1a by displaying a matched course selection image. Here, the course selection image may be the same as that generated in Act Sa3 or an image resulting from the addition of any image used in the guidance mode to the course selection image shown in FIG. 7. For example, the course selection image generated in Act Sb1 may only include the thumbnails of some of the practice courses registered in the practice course database.

In Act Sb2, the CPU 1m selects a practice course according to the selection of the user as it does in Act Sa4.

In Act Sb3, the CPU 1m starts playback a dynamic image corresponding to the selected practice course as it does in Act Sa5.

Then, the CPU 1m waits a timing stop or an operation end in Acts Sb4 and Sb5.

The CPU 1m determines the timing is stopped if the playback period of the dynamic image (named “the playback period” in the below) exceeds the elapsed time recorded in a setting file related to the selected practice course. Specifically, the CPU 1m makes a playback period determination at regular time. The CPU 1m may time the playback period of the dynamic image; if the time code of each frame is contained in the dynamic image file, the CPU 1m further makes a playback period determination according to the time code of a displayed frame, if the dynamic image file include the time code of each flame. The CPU 1m check the elapsed time with the playback period corresponding to a guidance setting file name recorded in the practice course database related to the selected practice mode, the CPU 1m compares the elapsed time recorded in the guidance setting file with the playback period. Further, the CPU 1m determines the timing should be stopped if each elapsed time recorded in the guidance setting file accords with the playback period, and then proceeds to Act Sb6 after executing Act Sb4.

In Act Sb6, the CPU 1m stops playback the dynamic image in the practice image.

In Act Sb7, the CPU 1m changes the input interface image according to the execution event recorded in the same setting information along with the elapsed time that is as long as the playback period.

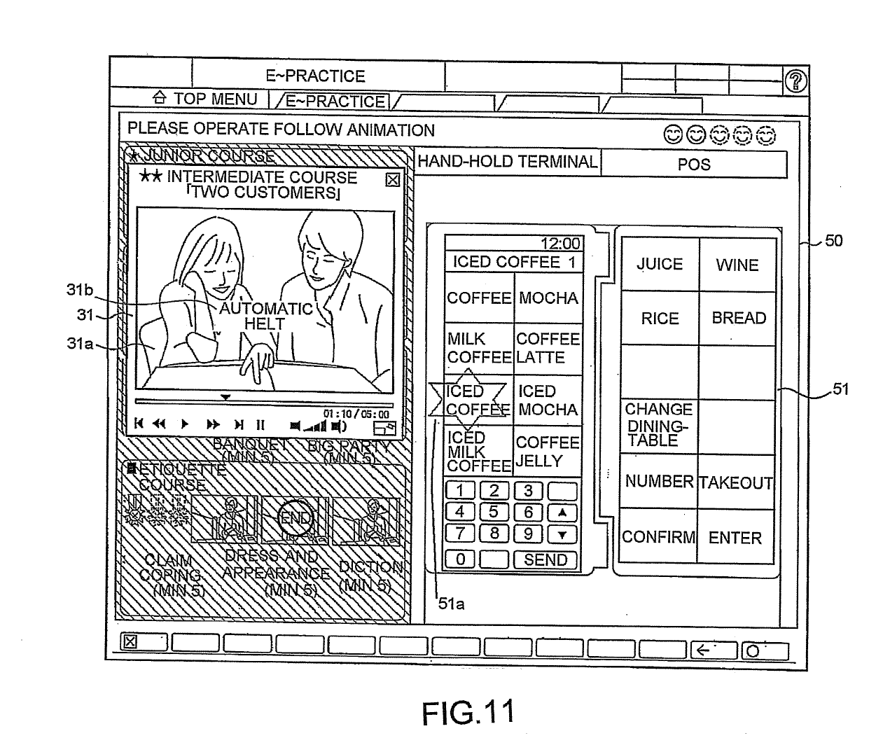

FIG. 11 is a diagram illustrating an example of a practice image resulting from a change on the input interface image while the playback of a dynamic image is paused.

The playback of the dynamic image 31 in the practice image 50 shown in FIG. 11 is paused at a generation moment ‘00:10’ according to the setting file shown in FIG. 5. Moreover, in the example shown in FIG. 11, a text 31b displaying the automatic playback stop of a dynamic image is overlapped on the dynamic image 31a. The input interface image 51 contained in the practice image is substantially identical to the input interface image 22, with the exception of flashing button 51a ‘iced coffee’. This change in the input interface image is an example of a record based on an execution event [‘iced coffee’ button•flash] contained in the setting file shown in FIG. 5.

The user seeing the practice image 50 can then recognize that it is time to start the timing for the button 51a ‘iced coffee’. Moreover, based on the recognition, the user presses the button 51a ‘iced coffee’.

Therefore, in Act Sb8, the CPU 1m wait to make a release trigger recorded in the same setting information along with the elapsed time that is as long as the playback period.

In the setting file shown in FIG. 5, the triggering for [the press on the button ‘iced coffee’] is disabled at a playback moment ‘00:10’ Therefore, if the aforementioned operation is carried out by the user, the CPU 1m determines the condition for the triggering disabling is met. Then, the CPU 1m proceeds to execute Act Sb9 after executing Act Sb8.

In Act Sb9, the CPU 1m initializes the input interface image to be in the state before the change of Act Sb7.

In Act Sb10, the CPU 1m starts playback the dynamic image in the practice image.

Then, the CPU 1m returns to the wait state described in Acts Sa6 and Sa7.

If an ending operation is carried out when the CPU 1m is in the wait state described in Acts Sb4 and Sb5, the CPU 1m skips the wait Act from Act Sb5 to execute the processing shown in FIG. 10. Then, the CPU 1m returns to execute the Act Sa2 shown in FIG. 6.

By using the aforementioned information terminal 1, the user can practice operating the hand-hold terminal 2 without causing any trouble to the other people.

Further, the information terminal automatically determines whether or not the user operates correctly and shows the user the result of the determination based on the existence condition of an ended flag 21j. Therefore, it can be determined whether or not the user operates correctly.

Further, the information terminal 1 shows the user a familiarity level. Therefore, the user can easily and correctly know how familiar he/she is with the operation of the hand-hold terminal 2.

Further, in the guidance mode, the information terminal 1 pauses the playback of a dynamic image at each timed moment indicating an event serving as a cue for a user operation. Therefore, the user can easily know the time for an operation, which is extremely beneficial for the user unfamiliar with the hand-hold terminal 2 to recognize the timing operation of the hand-hold terminal 2.

Moreover, in the guidance mode, the information terminal 1 halt the playback of the dynamic image in each timing represented an event cue of a cue for use operation. Therefore, the user can easily know what an operation should be carried out, which is extremely beneficial for the user unfamiliar with the hand-hold terminal 2 to recognize the operation of the hand-hold terminal 2.

This embodiment can have various variations.

It is allowable to realize either the playback of a dynamic image or a change on the input interface in the guidance mode.

The practice function may refer only to the actions given in the guidance mode.

By comparing the menu items contained in the list of the ordered menu item with those in a specified order, the menu items that are missed in an input or input by mistake can be distinguished and then shown to the user in image form.

The input interface image 22a can be replaced with the input interface image shown on the LCD 1a when the information terminal serves as a POS terminal. Moreover, if the operation shown on the input interface image is input, the user can practice operating the POS terminal.

The dynamic image can be replaced with a plurality of still images shown in the form of slide. That is, a plurality of still images can be automatically selected one by one at given time interval and then displayed on the LCD 11 as display objects.

The information terminal 1 having the practice function above may carry out other processing in addition to the services including guide, order acceptation, serving (dish serving) and charging.

The operation of the user (the practicer) is not limited to the order input. In addition, the event serving as a cue for a different operation of the user (the practicer) is different. Therefore, a dynamic or still image is shown that represents a cue event corresponding to an operation of the user (the practicer). Moreover, the user interface image is also configured to respond to an operation of the user (the practicer).

In addition to the method of determining the practice result by comparing the input operation with the given operation, other methods can also be used. For instance, the practice result can be determined by determining the consistency between the input operation and the given operation. Moreover, the practice result can be determined by adding such information as the order of input operations and the time for input operations. Or the actions above are achieved by a practice system including a terminal device and a server device. In the case, the user can practice using one or more terminal devices with one server device or a plurality of server devices.

Such practice systems can be realized through cloud calculation. More specifically, soft ware form which is called software as a service (SaaS) is good.

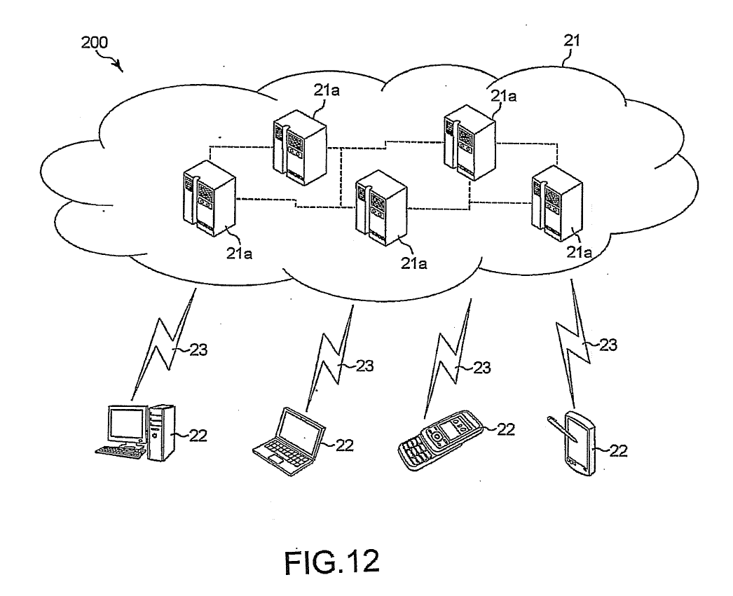

FIG. 12 is a diagram illustrating the structure of a practice system 200 using a cloud system.

The practice system 200 comprises a cloud 21, a plurality of terminal devices 22 and a plurality of communication networks 23. However, there may be one terminal device 22 and one communication network 23.

The cloud 21 further comprises a plurality of server devices 21a, which can communication with each other. However, there may be one server device 21a.

The terminal device 22 may communicate with the cloud 21 via the communication network 23. The terminal device 22 may be a mobile telephone, a personal digital assistant (PDA) or a smart phone and the like in some cases. The communication network 23 may be the Internet, a private network and the next generation network in some cases.

Moreover, the practice system 200 uses the cloud 21 to execute the Act Sa1 shown in FIG. 6, and Acts Sa2-Sa12 and Acts Sb1-Sb10 may also be executed in one of the cloud 21 and the terminal device 22. However, in Act Sa1, the terminal device 22 may also be used to recognize the input of the authentication information by the user.

The processing executed by the cloud 21 in Acts Sa1-Sa11 and Acts Sb1-Sb10 may also be executed in single server device 21a or a plurality of server devices 21a.

When the terminal device 22 is used to execute at least one of Acts Sa2-Sa1 and Acts Sb1-Sb10, the program for the computer of the terminal device 22 to execute the same Act may be pre-stored in the memory unit of the terminal device 22, or the program is stored in the memory unit of the cloud 21 in advance and provided to the terminal device 22 when needed. When the program is provided to the terminal device 22 from the cloud 21, at least one of the server devices 21a has a function of sending the program to the terminal device 22.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A practice apparatus for a user to practice operating an input device, comprising:
a display device;
a first controller, which controls the display device by displaying an input interface image which simulates an aspect of a user interface for inputting the operation to the input device in the first display area of the display device;
an input device for inputting the operation of the user on the input interface image displayed on the display; and
a second controller, which controls the display device by playback a dynamic image representing at least one cue event indicating a cue of the operation in the second display area of the display device, or by continuously displaying a plurality of still images including at least one image related to a cue event, and stops the playback of the dynamic image or the continuous display of the still images during the period from the moment an image related to a cue event is displayed to the moment an operation is input through the input device that is to be carried out by taking the cue event as a cue.

2. The practice apparatus according to claim 1, wherein
the first controller, in a condition that the playback of the dynamic image or the continuous display of the still images stop under the control of the second controller, change the interface image for user to recognize operation have to do under this condition.

3. The practice apparatus according to claim 1, further comprising:
a voice regenerator;
and a third controller for controlling the voice generator by playback a voice related to the dynamic image or the plurality of still images in synchronization with the playback of the dynamic image or the continuous display of the plurality of still images that is carried out under the control of the second controller.

4. A practice apparatus for a user to practicing operating an input device, comprising:
a display device;
a first controller, which controls the display by displaying an input interface image which simulates an aspect of a user interface for inputting the operation to the input device in the first display area of the display device;
an input device for inputting the operation of the user on the input interface image displayed on the display; and
a second controller, which controls the display device by playback a dynamic image representing at least one cue event indicating a cue of the operation in the second display area of the display, or by continuously displaying a plurality of still images including at least one image related to a cue event, wherein
the first controller, in a condition that the playback of the dynamic image or the continuous display of the still images stop under the control of the second controller, change the interface image for user to recognize operation have to do under this condition.

5. The practice apparatus according to claim 4, further comprising:
a voice regenerator; and
a third controller for controlling the voice generator by generating a voice related to the dynamic image or the plurality of still images in synchronization with the playback of the dynamic image or the continuous display of the plurality of still images that is carried out under the control of the second controller.

6. A control method for a practice apparatus comprising a display device and an input device for inputting the operation of the user on the input interface image displayed on the display and configured for the user to practice operating the input device, comprising:
controlling the display device by displaying an input interface image which simulates an aspect of a user interface for inputting the operation to the input device in the first display area of the display device;
controlling the display device by playback a dynamic image representing at least one cue event indicating a cue of the operation in the second display area of the display device, or by continuously displaying a plurality of still images including at least one image related to a cue event; and
stopping the playback of the dynamic image or the continuous display of the still images during the period from the moment an image related to a cue event is displayed to the moment an operation is input through the input device that is to be carried out by taking the cue event as a cue.

7. The control method according to claim 6, wherein
changing the interface image for user to recognize operation have to do in a condition that the playback of the dynamic image or the continuous display of the still images stop.

8. The control method according to claim 6, wherein
the practice apparatus include a regenerator which regenerate a voice;
controlling the generator by generating a voice related to the dynamic image or the plurality of still images in synchronization with the playback of the dynamic image or the continuous display of the plurality of still images.

9. A control method for a practice apparatus comprising a display device and an input device for inputting the operation of the user on the input interface image displayed on the display and configured for the user to practice operating the input device, comprising:
controlling the display device by displaying an input interface image which simulates an aspect of a user interface for inputting the operation to the input device in the first display area of the display device;
controlling the display device by playback a dynamic image representing at least one cue event indicating a cue of the operation in the second display area of the display device, or by continuously displaying a plurality of still images including at least one image related to a cue event; and
changing the interface image for user to recognize operation have to do in a condition that the playback of the dynamic image or the continuous display of the still images stop.

10. The control method according to claim 9, wherein
the practice apparatus include a regenerator which regenerate a voice;
controlling the generator by generating a voice related to the dynamic image or the plurality of still images in synchronization with the playback of the dynamic image or the continuous display of the plurality of still images.

11. A practice system for a user to practice operating an input device, include at least one server and at least one terminal, comprising:
a display device;
a first controller, which controls the display device by displaying an input interface image which simulates an aspect of a user interface for inputting the operation to the input device in the first display area of the display device;
an input device for inputting the operation of the user on the input interface image displayed on the display; and
a second controller, which controls the display device by playback a dynamic image representing at least one cue event indicating a cue of the operation in the second display area of the display device, or by continuously displaying a plurality of still images including at least one image related to a cue event, and stops the playback of the dynamic image or the continuous display of the still images during the period from the moment an image related to a cue event is displayed to the moment an operation is input through the input device that is to be carried out by taking the cue event as a cue; wherein
the server include at least one of the first controller and the second controller;
the terminal include a device that is not included in the server of the first controller and the second controller.
